(19) United States
(12) Patent Application Publication
(10) Pub. No.: US 2009/0093578 A1
(43) Pub. Date: Apr. 9, 2009

(54) TRANSPARENT STRETCHED ACRYLIC SHEETS FOR AIRCRAFT WINDOW SYSTEMS HAVING CONTROLLED SOLAR TRANSMITTANCE PROPERTIES

(76) Inventor: Carlos Guerra, Fairfield, CT (US)

Correspondence Address: Patent Docket Department;Armstrong Teasdale LLP, One Metropolitan Square, Suite 2600, St. Louis, MO, 63102-2740, US

(21) Appl. No.: 12/269,545

(22) Filed: Nov. 12, 2008

Related U.S. Application Data
(63) Continuation-in-part of application No. 11/796,314, filed on Apr. 27, 2007.
Application No. 11/796,314 is a continuation-in-part of application No. 11/370,613, filed on Mar. 8, 2006.
(60) Provisional application No. 60/987,454, filed on Nov. 13, 2007.

(51) Int. Cl. C08K 3/38; B29D 7/00; C08L 31/02

(52) U.S. Cl. 524/404; 264/212; 524/556

(57) ABSTRACT

A biaxially stretched transparent acrylic sheet having a controlled solar energy transmittance properties for aircraft window systems is described. The biaxially stretched transparent acrylic sheet includes a thermoplastic acrylic polymer, and from about 0.003 percent by weight to about 0.1 percent by weight of an IR absorbing material, the weight percentage based on the a total weight of the acrylic polymer and the IR absorbing material. The IR absorbing material preferentially absorbs energy having wavelengths from about 700 nm to about 1100 nm. The IR absorbing material is selected from the group consisting of perylene based dyes, nanoparticle hexaboride based IR absorbers, and mixtures thereof.

### CROSS REFERENCE TO RELATED APPLICATIONS

This application is a Continuation-In-Part of U.S. patent application Ser. No. 11/796,314 filed Apr. 27, 2007, which is a Continuation-In-Part of U.S. patent application Ser. No. 11/370,613 filed Mar. 8, 2006. This application also claims the benefit of U.S. Provisional Patent Application No. 60/987,454 filed Nov. 13, 2007, which is hereby incorporated by reference in its entirety.

### BACKGROUND OF THE INVENTION

This invention relates generally to transparent stretched acrylic sheets for aircraft transparencies and window systems, and more particularly, to transparent stretched acrylic sheets having a reduced solar energy transmittance over known aircraft transparencies and window systems.

Transparent plastics are sometimes used for windows in buildings, vehicles, airplanes, telephone booths, etc. Solar energy easily passes through transparent plastics and can raise the temperature of the area inside, for example, an airplane, and particularly the cockpit of an airplane.

There are a number of applications where plastics are used to allow the passage of useful visible light while at the same time controlling the amount of solar energy (heat) transmitted through the plastic. It is known to attempt to control the transmission of solar energy using thin films and coatings containing dyes, pigments carbon black, metal oxides, for example, FeOₓ, CoOₓ, CrOₓ, and TiOₓ, and metals, for example Ag, Au, Cu, Ni, and Al. However, these known films reduce both infrared light (heat) and visible light. Also, when these films or coatings are applied to transparent plastic flat sheets, the resulting product usually cannot be thermoformed. Additionally, the coatings and films are difficult and expensive to apply to a formed shape, for example aircraft transparencies, canopies, and window systems.

### BRIEF DESCRIPTION OF THE INVENTION

In one aspect, a method of making a biaxially stretched transparent acrylic sheet with controlled solar energy transmittance properties is provided. The method includes providing a fluid thermoplastic acrylic material, and adding from about 0.003 percent by weight to about 0.1 percent by weight of an IR absorbing material, the weight percentage based on the a total weight of the acrylic material and the IR absorbing material to form a fluid mixture of thermoplastic acrylic material and IR absorbing material. The IR absorbing material preferentially absorbs energy having wavelengths from about 700 nm to about 1100 nm. The IR absorbing material may be selected from the group consisting of perylene based dyes, nanoparticle hexaboride based IR absorbers, and mixtures thereof. The method also includes casting the fluid mixture into a sheet mold to form a cast acrylic sheet, heating the cast acrylic sheet, and biaxially stretching the cast acrylic sheet to form a biaxially stretched transparent acrylic sheet with controlled solar energy transmittance properties.

In another aspect, a biaxially stretched transparent acrylic sheet having a controlled solar energy transmittance properties is provided. The biaxially stretched transparent acrylic sheet includes a thermoplastic acrylic polymer, and from about 0.003 percent by weight to about 0.1 percent by weight of an IR absorbing material, the weight percentage based on the a total weight of the acrylic polymer and the IR absorbing material. The IR absorbing material preferentially absorbs energy having wavelengths from about 700 nm to about 1100 nm. The IR absorbing material is selected from the group consisting of perylene based dyes, nanoparticle hexaboride based IR absorbers, and mixtures thereof.

A multi-layered aircraft window is provided. The multi-layered aircraft window includes an outer layer and an inner layer, where an outer surface of the outer layer is positioned to face outside an aircraft. The outer layer is formed from a biaxially stretched transparent acrylic sheet. The biaxially stretched transparent acrylic sheet includes a thermoplastic acrylic polymer, and from about 0.003 percent by weight to about 0.1 percent by weight of an IR absorbing material, the weight percentage based on the a total weight of the acrylic polymer and the IR absorbing material. The IR absorbing material preferentially absorbs energy having wavelengths from about 700 nm to about 1100 nm. The IR absorbing material is selected from the group consisting of perylene based dyes, nanoparticle hexaboride based IR absorbers, and mixtures thereof.

### DETAILED DESCRIPTION OF THE INVENTION

A transparent stretched acrylic sheet having controlled solar energy transmission properties and methods of making the stretched acrylic sheet is described below in detail. The transparent stretched acrylic sheet is formed from a thermoplastic acrylic polymer and from about 0.003 to about 0.1 weight percent of an IR absorbing material having the ability to preferentially absorb solar energy between the wavelengths of about 700 nm to about 1100 nm. The IR absorbing material reduces the ratio of IR light to visible light transmitted through the stretched acrylic sheet. Because less IR light is transmitted through the stretched acrylic sheet for a given amount of visible light, less heat is transmitted through the stretched acrylic sheet. This phenomenon is desirable in applications such as aircraft window systems where the interior space is small relative to the size of the windows and/or transparencies. The IR absorbing material includes a perylene based dye and/or a hexaboride based nanoparticle IR absorber.

In an exemplary embodiment, a transparent stretched acrylic sheet is formed from one or more monomers that are subsequently polymerized to form a thermoplastic acrylic polymer, that includes from about 0.003 to about 0.1 weight percent of an IR absorbing material based on the total weight of the thermoplastic acrylic polymer and the IR absorbing material. The IR absorbing material preferentially absorbs solar energy between the wavelengths of about 700 nanometers (nm) to about 1100 mm.

A fluid mixture of thermoplastic acrylic polymer and IR absorbing material is cast into a sheet mold, cooled, and removed from the sheet mold to form a cast acrylic sheet. The transparent cast acrylic sheet is heated above its softening temperature, for example, from about 300° F. to about 375° F. (about 145° C. to about 190° C.), and then biaxially stretched by stretching or pulling in both the x and y axial directions. The transparent biaxially stretched cast acrylic sheet is then cooled under tension, that is, while being stretched, to form a stretched acrylic sheet that is at least 1.5 times larger in length and in width as compared to the original unstretched sheet, and about 20% to about 40% the thickness of the original unstretched sheet.

Suitable thermoplastic acrylic polymers are formed, in one embodiment, by polymerizing an alkyl (meth)acrylate monomer. The thermoplastic acrylic polymers can be copolymers of one or more alkyl esters of acrylic acid or methacrylic acid having from 1 to 20 carbon atoms in the alkyl group optionally together with one or more other polymerizable ethylenically unsaturated monomers. Suitable alkyl esters of acrylic acid or methacrylic acid include methyl (meth)acrylate, isobutyl (meth)acrylate, alpha-methyl styrene dimer, ethyl (meth)acrylate, n-butyl (meth)acrylate, and 2-ethylhexyl (meth)acrylate. Suitable other copolymerizable ethylenically unsaturated monomers include vinyl aromatic compounds such as styrene and vinyl toluene; nitrites such as acrylonitrile and methacrylonitrile; vinyl and vinylidene halides such as vinyl chloride and vinylidene fluoride and vinyl esters such as vinyl acetate. It should be understood that the term “(meth)acrylate” refers to both methacrylate and acrylate. In addition, reactive monomers of the above described monomers having more than one reactive site can also be used in combination with non-reactive monomers.

In one embodiment, the transparent biaxially stretched cast acrylic sheet permits at least about 75 percent transmission of visible light, in another embodiment, at least about 50 percent transmission of visible light, and in another embodiment, at least about 15 percent transmission of visible light while absorbing solar energy having wavelengths of from about 700 nm and about 1100 nm. In addition, the transparent biaxially stretched cast acrylic sheet has improved physical properties as compared to a cast acrylic sheet, for example, increased resistance to crack propagation and increased resistance to crazing due to chemical attack. Furthermore, the transparent biaxially stretched cast acrylic sheet meets the requirements set forth in U.S. Military Specification MIL P 25690. The visible and infrared radiation transmission properties of an acrylic sheet are virtually unchanged by the stretching process, other than by the obvious effects caused by thickness reduction compared to an unstretched acrylic sheet. A transparent biaxially stretched cast acrylic sheet can be produced both colorless and tinted. A colorless cast acrylic sheet and a colorless biaxially stretched cast acrylic sheet of the same thickness will have essentially the same spectral transmission properties. Therefore, it is believed that a tinted cast acrylic sheet and a tinted biaxially stretched cast acrylic sheet, both with the same visible light transmission properties will also have the same total solar energy transmission properties.

It should be understood that as used herein, the term “formed from” denotes open, e.g., “comprising”, claim language. As such, it is intended that a composition “formed from” a list of components be a composition that includes at least these recited components, and can further include other, nonrecited components, during the composition's formation, for example UV absorbers, surfactants, pigments, and the like.

The IR absorbing material is incorporated into the thermoplastic acrylic monomer(s) by any suitable method, for example, using a mixing tank and a simple stirring apparatus; or using high energy dispersion equipment such as Cowles blades, mills, attritters, and the like.

In one embodiment, the IR absorbing material is a perylene based dye capable of preferentially absorbing energy having wavelengths of from about 700 nm to about 1100 nm. In another embodiment, the IR absorbing material is a nanoparticle hexaboride IR absorber. In another embodiment, the IR absorbing material is a mixture of perylene based dye and a nanoparticle hexaboride IR absorber where the ratio of the amount of perylene based dye to the amount of nanoparticle hexaboride IR absorber is about 99:1 to about 1:99 by weight, in another embodiment about 75:1 to about 1:75 by weight, and in another embodiment about 50:1 to about 1:50 by weight.

As noted above, perylene-based dyes are suitable IR absorbing material for use in the present disclosure. As will be recognized by one skilled in the art based on the disclosure herein, the perylene chemical structure in the perylene based dyes used can be changed by the addition of other chemical groups which can modify the maximum absorption region in the infrared spectrum. Suitable perylene based dyes are commercially available from, for example, BASF Corporation, Florham Park, N.J., under the Lumogen® IR trademark, for example, Lumogen® IR788 perylene-based dye and Lumogen® IR765 perylene-based dye.

The nanoparticle hexaboride IR absorber includes particles of hexaboride having a particle size of about 200 nm or less, suitably about 100 nm or less. The hexaboride may be selected from YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof. The nanoparticle hexaboride IR absorber can also include particles of SiO₂, TiO₂, ZrO₂, Al₂O₃, or MgO having a particle size in one embodiment of about 200 nm or less, and in another embodiment of about 100 nm or less. The nanoparticle hexaboride IR absorber can also include other materials, for example, organic dispersing agents and/or organic solvents. Suitable nanoparticle hexaboride IR absorbers are commercially available from, for example, Sumitomo Metal Mining Co., Ltd, Tokyo, Japan, for example KHDS-02 IR absorber.

The IR absorbing materials described above are substantially non-reactive in the context of free-radical acrylic polymerization. In addition, the concentration of the IR absorbing material is from about 0.003 to about 0.1 weight percent. Consequently, the properties of the stretched acrylic sheet described above remain essentially unaffected by the IR absorbing material additions, and comply with MIL P 25690.

The biaxially stretched cast acrylic sheet described above can be used to fabricate one, two, and three ply window systems and one, two, and three ply laminates used as cockpits, windscreens and windows for airplanes and helicopters. These materials will have improved solar energy reduction properties over acrylic sheets tinted using traditional colorants.

Known colored stretched acrylic sheets are produced using a number of traditional pigment dispersions and/or solvent dyes. The purpose of tinting such sheets is to reduce glare and heat inside aircraft; solar energy is the source of the heat. While these known tinted stretched acrylic sheets do reduce the heat, they also reduce the visible light transmission in approximately equivalent amounts. The IR absorbing materials described above also reduce the solar energy transmission but with a smaller impact on the visible light transmission when compared to traditional colorants. In addition, the same visible light transmission can be maintained but with a greater reduction in solar energy transmission (heat) with the IR absorber materials described above. These IR absorber materials can be incorporated into formulations at such levels and combinations as to yield the desired optical properties after stretching, for example, from about 0.003 to about 0.1 weight percent.

The following examples which are presented for the purpose of illustration only and are not intended to limit the scope of the claims. Unless otherwise indicated, all amounts are listed as parts by weight.

### EXAMPLES

Five types of cast acrylic sheet were compared for solar energy transmission; (1) a colorless acrylic sheet (A) having a visible light transmission (VLT) of 92%; (2) a light green acrylic sheet (B) tinted with traditional colorants, and having a visible light transmission of 77%; (3, 4, and 5) a light green acrylic sheet (C, D, and E) tinted with different amounts of a blend of a perylene based dye and a hexaboride IR absorber, having a visible light transmission of 77%, 89%, and 58% respectively. Results were obtained using values and calculations for cast acrylic sheet data and by actual testing as-cast acrylic sheet samples. Cast acrylic sheets were used to simulate biaxially stretched cast acrylic sheets because a colorless cast acrylic sheet and a colorless stretched acrylic sheet of the same thickness have essentially the same spectral transmission properties, and it is believed that a tinted cast acrylic sheet and a tinted stretched acrylic sheet, both with the same visible light transmission properties, will also have the same total solar energy transmission properties. Table I below shows the composition of Acrylic Sheets A-E, All ingredients are listed as parts by weight.

TABLE I

| Ingredients | A | B | C | D | E |
|---|---|---|---|---|---|
| Methyl Methacrylate | 99 | 99 | 99 | 99 | 99 |
| Monomer | | | | | |
| Azo-Type Free Radical | 0.09 | 0.09 | 0.09 | 0.09 | 0.09 |
| Initiator | | | | | |
| Chain Regulator | 0.02 | 0.02 | 0.02 | 0.02 | 0.02 |
| UV Absorber | 0.1 | 0.1 | 0.1 | 0.1 | 0.1 |
| Perylene-Based Dye* | 0 | 0 | 0.001 | 0.0005 | 0.002 |
| Hexaboride IR | 0 | 0 | 0.028 | 0.003 | 0.070 |
| Absorber** | | | | | |
| Phthalo Green + Carbon | 0 | 0.008 | 0 | 0 | 0 |
| Black Pigments | | | | | |

*LUMOGEN IR 788 commercially available from BASF Corporation.
**KHDS-872G2 (containing LaB₆) commercially available from Sumitomo Metal Mining Co., Ltd.

Sample Preparation: The ingredients for each acrylic sheet B-E were dissolved or dispersed in the liquid acrylic monomer. The amounts of the perylene based dye, the hexaboride IR absorber, and the pigment colorants were selected so that Samples B and C each had a percent visible light transmission (VLT) of about 77%. The mixture acrylic monomer and IR absorbing material(s) was degassed and then poured inside a casting mold. The mold consisted of two glass plates separated by a soft gasket material and the assembly was kept together by spring clamps. The molds containing the test mixtures were placed in air-circulating ovens to polymerize. The casting cycles includes about 6 hours at about 60° C. followed by 1 to 3 hours at temperatures of about 100° C. A slow cooling period of about 1 hour followed to reduce the temperature of the cast acrylic sheet to ambient temperature. At the end of the casting process, the clamps were removed and the glass plates were separated from the resulting acrylic sheet.

Testing of Acrylic Sheets A-E included solar heat gain calculations using software developed by Lawrence Berkeley National Labs (LBNL). The software predicts the relative amounts of heat allowed to pass through different glazing systems. The specific products used were OPTICS 5.1 and WINDOW 5.2. These programs use the spectral transmission values and other physical and optical properties of glazing materials to do the energy transmission calculations. The testing also involved using an outdoor solar collector apparatus, described below, to simultaneously collect and measure the solar heat that passes through two side-by side glazing systems. The relative energy transmission properties of various pairs of glazing systems can thus be compared under equal weather conditions.

WINDOW 5.2 provides a versatile heat transfer analysis method consistent with the updated rating procedure developed by the National Fenestration Rating Council (NFRC). The program can be used to design and develop new products, to assist educators in teaching heat transfer through windows, and to help public officials in developing building energy codes. OPTICS 5.1 calculates the solar, infrared and visible light transmittance/reflectance property of the acrylic sheet and then the results are transferred to WINDOW 5.2 for determining relative gain in heat energy of the interior due to solar radiation. Glazing systems consisted of single ply, three-ply systems and two-ply laminates which were designed in WINDOW 5.2. For the three-ply system, the tinted sheet (either B or C) was tested in two scenarios. In the first case, the tinted sheet is the outer ply and in the other case it as the inner ply of the glazing system. Relative heat gain by the for the designs is calculated based on NFRC 100-2001—Summer Conditions.

Simulations for single ply glazing systems were performed using 0.187 inch thick acrylic sheets. Simulations for three-ply glazing systems were performed using the following design; three layers of 0.187 inch thick acrylic sheet material with an airspace of 0.170 inch between the outer layer and the middle layer and between the inner layer and the middle layer. Simulations for two ply laminates were performed using two layers of 0.187 inch thick acrylic bonded together.

### Example I

Acrylic sheets A-E were compared using WINDOW 5.2 and OPTICS 5.1. Relative heat gain was calculated and the results from acrylic sheets B, C, D, and E were compared to acrylic sheet A (clear acrylic sheet with out any IR absorbers). Test results are shown in Table II.

TABLE II

| | | % Heat | |
|---|---|---|---|
| | Relative Heat | Reduction | |
| Plastic Sheet | Gain (Btu/h-ft²) | vs. Sheet A | % VLT |
| A | 213 | — | 92 |
| B | 197 | 8 | 77 |
| C | 161 | 24 | 77 |
| D | 206 | 3 | 89 |
| E | 118 | 45 | 58 |

### Example II

Three ply glazing systems were compared using WINDOW 5.2 and OPTICS 5.1. Relative heat gain was calculated and the results from glazing systems II and III were compared to glazing system I (clear acrylic sheet A with out any IR absorbers is used in each ply). Glazing system II utilizes acrylic sheet B as the outer ply and glazing system III utilizes acrylic sheet as the outer ply. The calculations were performed with the first or outer ply faces the sun and the third or inner ply faces the interior of the aircraft. Test results are shown in Table III.

TABLE III

| | | | | Relative | % Heat |
|---|---|---|---|---|---|
| Glazing | Outer | | | Heat Gain | Reduction vs. |
| System | Ply | Middle Ply | Inner ply | (Btu/h-ft²) | System I |
| I | A | A | A | 167 | — |
| II | B | A | A | 152 | 9 |
| III | C | A | A | 116 | 31 |

### Example III

Three ply glazing systems were compared using WINDOW 5.2 and OPTICS 5.1. Relative heat gain was calculated and the results from glazing systems IV and V were compared to glazing system I (clear acrylic sheet A with out any IR absorbers is used in each ply). Glazing system IV utilizes acrylic sheet B as the inner ply and glazing system V utilizes acrylic sheet as the inner ply. The calculations were performed with the first or outer ply faces the sun and the third or inner ply faces the interior of the aircraft. Test results are shown in Table IV.

TABLE IV

| | | | | Relative Heat | % Heat |
|---|---|---|---|---|---|
| Glazing | | | | Gain | Reduction vs. |
| System | Outer Ply | 2nd Ply | 3rd ply | (Btu/h-ft²) | System I |
| I | A | A | A | 168 | — |
| IV | A | A | B | 162 | 4 |
| V | A | A | C | 151 | 10 |

### Example IV

Two ply laminates were compared using WINDOW 5.2 and OPTICS 5.1. Each laminate includes an outer ply of an acrylic sheet having a thickness of 0.187 inch and an inner ply of an acrylic sheet having a thickness of 0.187 inch bonded together by a 15 mil interlayer of polyvinyl buterate (PVB) adhesive film, Butacite NCO10 commercially available from DuPont. Test results are shown in Table V.

TABLE V

| | | Relative Heat |
|---|---|---|
| Outer Layer | Inner Layer | Gain |
| Acrylic Sheet | Acrylic Sheet | (Btu/h-ft²) |
| A | A | 208 |
| B | A | 194 |
| C | A | 160 |

### Example V

The same materials used in Example I were tested using an outdoor solar collector apparatus. The solar collector was constructed with 2 compartments. The window opening of both compartments have similar dimensions to permit passage of available energy (sunlight). An opening of 3 inches by 4 inches was used for each compartment. Test acrylic sheets were placed over the window opening. The solar collector was periodically re-oriented in such a way that the windows faced directly towards the sun. The temperature differences inside the solar collector compartments were recorded for acrylic sheets A-C. The standard of reference was clear sheet A. By comparing test sheets B and C to clear sheet A, relative heat gain for all can be obtained.

Temperature measurements were recorded by thermocouples placed inside the compartments. A third thermocouple measured the outside air temperature. All tests ended when both compartments reached steady state heat transfer. The column labeled “PEAK TEMPERATURE” gives the temperature inside the reference (sheet A) compartment. The temperature difference between the test sheet and the reference sheet are given under the column labeled “DELTA TEMP”. A negative value indicates a cooler interior than the reference compartment. Test results are shown in Table VI.

TABLE VI

| | | Peak | Delta | | |
|---|---|---|---|---|---|
| | % Visible | Temp. | Temp (F.) | Avg. | Avg. Wind |
| Plastic | Light | Sheet | Relative To | Ambient | Speed |
| Sheet | Transmission | A (F.) | Sheet A | Temp (F). | (Miles/Hr) |
| A | 93 | 186.1 | 0.0 | 69.8 | — |
| B | 77 | 178.9 | −7.2 | 75.2 | 5 |
| C | 77 | 165.9 | −20.2 | 63.0 | 2 |

### Example VI

The 3-ply glazing systems compared in Example II were compared using the outdoor solar collector apparatus described above. Test results are shown in Table VII.

TABLE VII

| | | Peak | Delta | | |
|---|---|---|---|---|---|
| | % Visible | Temp. | Temp (F.) | Avg. | Avg. Wind |
| Glazing | Light | Sheet | Relative To | Ambient | Speed |
| System | Transmission | A (F.) | System I | Temp (F.) | (Miles/Hr) |
| I | 80 | — | — | — | — |
| II | 66 | 188.6 | −9.9 | 70.3 | 2 |
| III | 67 | 200.8 | −30.6 | 85.6 | 1 |

### Example VII

The 3-ply glazing systems compared in Example II were compared using the outdoor solar collector apparatus described above. Test results are shown in Table VIII.

TABLE VIII

| | | Peak | Delta | | |
|---|---|---|---|---|---|
| | % Visible | Temp. | Temp (F.) | Avg. | Avg. Wind |
| Glazing | Light | Sheet | Relative To | Ambient | Speed |
| System | Transmission | A (F.) | System I | Temp (F.) | (Miles/Hr) |
| I | — | — | — | — | 1 |
| IV | 66 | 194.4 | −3.2 | 74.1 | 1 |
| V | 67 | 194.2 | −12.1 | 79.3 | — |

The above examples show that there is a correlation between the relative heat gain results of the software simulations and the actual temperature measurements using the outdoor solar collector apparatus. Both methods demonstrate that a single ply of tinted acrylic sheet C made in accordance with an embodiment of the present invention, result in lower heat build up than the single ply acrylic sheet B made using traditional colorants. The acrylic sheets made in accordance with an embodiment of the present invention block heat by absorbing near infrared radiation. The radiation is absorbed in the acrylic sheet and then a significant amount gets re-radiated back to the outside. Some aircraft use stretched acrylic in single ply glazing systems, other designs have more than one layer.

When the tinted acrylic is placed as the innermost ply in multilayer systems, some of the heat reduction properties are lost, and the nature of the colorants is less significant. The absorbed heat cannot be re-radiated back to the outside because of the two other layers of acrylic in front of it. However, when the tinted acrylic, made in accordance with an embodiment of the present invention, is the outermost ply in multilayer systems, the heat reduction advantage of the acrylic sheet gets further enhanced. In this case the layers of acrylic behind it prevent the absorbed heat from radiating towards the interior.

While the invention has been described in terms of various specific embodiments, those skilled in the art will recognize that the invention can be practiced with modification within the spirit and scope of the claims.

What is claimed is:

1. Method of making a biaxially stretched transparent acrylic sheet with controlled solar energy transmittance properties, said method comprising:
providing at least one acrylic monomer;
adding from about 0.003 percent by weight to about 0.1 percent by weight of an IR absorbing material, the weight percentage based on the a total weight of the at least one acrylic monomer and the IR absorbing material to form a fluid mixture of the at least one acrylic monomer and IR absorbing material, the IR absorbing material capable of preferentially absorbing energy having wavelengths from about 700 nm to about 1100 nm, the IR absorbing material selected from the group consisting of perylene based dyes, nanoparticle hexaboride based IR absorbers, and mixtures thereof;
polymerizing the at least one acrylic monomer by heating the at least one acrylic monomer and IR absorbing material mixture;
casting the mixture into a sheet mold to form a cast acrylic sheet;
heating the cast acrylic sheet; and
biaxially stretching the cast acrylic sheet to form a biaxially stretched transparent acrylic sheet with controlled solar energy transmittance properties.

2. A method in accordance with claim 1 comprising adding from about 0.005 percent by weight to about 0.05 percent by weight of the IR absorbing material.

3. A method in accordance with claim 1 comprising adding from about 0.006 percent by weight to about 0.03 percent by weight of the IR absorbing material.

4. A method in accordance with claim 1 wherein providing at least one acrylic monomer comprises providing an alkyl (meth)acrylate monomer.

5. A method in accordance with claim 1 wherein adding from about 0.005 percent by weight to about 0.05 percent by weight of the IR absorbing material comprises at least one of dispersing the IR absorbing material in the thermoplastic acrylic material and dissolving the IR absorbing material in the thermoplastic acrylic material.

6. A method in accordance with claim 1 wherein providing at least one acrylic monomer comprises providing an alkyl (meth)acrylate monomer, and wherein adding from about 0.003 percent by weight to about 0.1 percent by weight of the IR absorbing material comprises:
dispersing the IR absorbing material in the alkyl (meth)acrylate monomer; and
polymerizing the alkyl (meth)acrylate monomer by heating the alkyl (meth)acrylate monomer and IR absorbing material dispersion.

7. A method in accordance with claim 6 wherein the IR absorbing material comprises a perylene based dye and a nanoparticle hexaboride based IR absorber, a ratio of an amount of the perylene based dye to an amount of the nanoparticle hexaboride IR absorber comprising about 99:1 to about 1:99.

8. A method in accordance with claim 1 wherein the nanoparticle hexabromide based IR absorber comprises hexabromide particles selected from the group consisting of YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof.

9. A method in accordance with claim 1 wherein the nanoparticle hexabromide based IR absorber comprises hexabromide particles having a particle size of about 200 nm or less.

10. A method in accordance with claim 1 wherein the nanoparticle hexabromide based IR absorber comprises hexabromide particles having a particle size of about 100 nm or less.

11. A biaxially stretched transparent acrylic sheet having a controlled solar energy transmittance properties, said biaxially stretched transparent acrylic sheet comprising:
a thermoplastic acrylic polymer; and
from about 0.003 percent by weight to about 0.1 percent by weight of an IR absorbing material, the weight percentage based on the a total weight of said acrylic polymer and said IR absorbing material, said IR absorbing material capable of preferentially absorbing energy having wavelengths from about 700 nm to about 1100 nm, said IR absorbing material selected from the group consisting of perylene based dyes, nanoparticle hexaboride based IR absorbers, and mixtures thereof.

12. A biaxially stretched transparent acrylic sheet in accordance with claim 11 comprising from about 0.005 percent by weight to about 0.05 percent by weight of said IR absorbing material.

13. A biaxially stretched transparent acrylic sheet in accordance with claim 11 comprising from about 0.006 percent by weight to about 0.03 percent by weight of said IR absorbing material.

14. A biaxially stretched transparent acrylic sheet in accordance with claim 11 wherein said IR absorbing material comprises a perylene based dye and a nanoparticle hexaboride based IR absorber, a ratio of an amount of said perylene based dye to an amount of said nanoparticle hexaboride IR absorber comprising about 99:1 to about 1:99.

15. A biaxially stretched transparent acrylic sheet in accordance with claim 11 wherein said nanoparticle hexabromide based IR absorber comprises hexabromide particles selected from the group consisting of YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof.

16. A biaxially stretched transparent acrylic sheet in accordance with claim 11 wherein said nanoparticle hexabromide based IR absorber comprises hexabromide particles having a particle size of about 200 nm or less.

17. A biaxially stretched transparent acrylic sheet in accordance with claim 11 wherein said biaxially stretched transparent acrylic sheet permits at least about 75 percent transmission of visible light.

18. A biaxially stretched transparent acrylic sheet in accordance with claim 11 wherein said biaxially stretched transparent acrylic sheet permits at least about 50 percent transmission of visible light.

19. A biaxially stretched transparent acrylic sheet in accordance with claim 11 wherein said biaxially stretched transparent acrylic sheet permits at least about 15 percent transmission of visible light.

20. A multi-layered aircraft window comprising an outer layer and an inner layer, an outer surface of said outer layer is positioned to face outside an aircraft, said outer layer comprising a biaxially stretched transparent acrylic sheet, said biaxially stretched transparent acrylic sheet comprising:
a thermoplastic acrylic polymer; and
from about 0.003 percent by weight to about 0.1 percent by weight of an IR absorbing material, the weight percentage based on the a total weight of said acrylic polymer and said IR absorbing material, said IR absorbing material capable of preferentially absorbing energy having wavelengths from about 700 nm to about 1100 nm, said IR absorbing material selected from the group consisting of perylene based dyes, nanoparticle hexaboride based IR absorbers, and mixtures thereof.

21. A multi-layered aircraft window in accordance with claim 20 wherein said IR absorbing material comprises a perylene based dye and a nanoparticle hexaboride based IR absorber, a ratio of an amount of said perylene based dye to an amount of said nanoparticle hexaboride IR absorber comprising about 99:1 to about 1:99.

22. A multi-layered aircraft window accordance with claim 11 wherein said nanoparticle hexabromide based IR absorber comprises hexabromide particles having a particle size of about 200 nm or less.

23. A multi-layered aircraft window in accordance with claim 11 wherein said biaxially stretched transparent acrylic sheet permits at least about 75 percent transmission of visible light.

24. A multi-layered aircraft window in accordance with claim 11 wherein said biaxially stretched transparent acrylic sheet permits at least about 50 percent transmission of visible light.
